(19) United States
(12) Patent Application Publication
(10) Pub. No.: US 2016/0042366 A1
(43) Pub. Date: Feb. 11, 2016

(54) SYSTEM AND METHOD FOR MONITORING COMPETITIVE PERFORMANCE OF BRANDS

(71) Applicant: Meelo Logic, Inc., New York, NY (US)

(72) Inventors: Mina Lux, Cliffside Park, NJ (US); Theodore Green, New York, NY (US)

(21) Appl. No.: 14/818,642

(22) Filed: Aug. 5, 2015

Related U.S. Application Data
(60) Provisional application No. 62/033,392, filed on Aug. 5, 2014.

(51) Int. Cl. G06Q 30/02; G06F 17/30

(52) U.S. Cl. CPC G06Q 30/0201; G06F 17/30867; G06F 17/30321

(57) ABSTRACT

Described herein are systems and methods for monitoring competitive performance of brands. In one embodiment, a method includes aggregating data from a plurality of content sources, the aggregated data being descriptive of a plurality of content items. The aggregated data is filtered based at least partially on a brand identifier to identify a subset of the plurality of content items within the aggregated data. For each content item of the subset, an associated ontological record is generated, each ontological record including an identifier of its associated content item, an identifier of an associated content source of the plurality of content sources from which the content item is sourced, and a descriptor of a relationship between the associated content item and one or more content items of the subset.

### CROSS-REFERENCE TO RELATED APPLICATION

This application claims the benefit of priority of U.S. Provisional Patent Application Ser. No. 62/033,392, filed on Aug. 5, 2014, which is hereby incorporated by reference herein in its entirety.

### FIELD OF THE INVENTION

Embodiments of the invention relate generally to the fields of marketing and advertising and, more specifically, to a system and method of monitoring performance of computer-mediated information for use in brand management, content publishing, marketing, message distribution, and public relations.

### BACKGROUND

A “brand” represents a collection of information attributes related to a commercial presence of an organization including, but not limited to, brand names, business names, celebrity names, mottos, mission statements, marketing language and related wording (e.g., keywords, market verticals, topics, etc.), images, press and media mentions, and user-generated content (e.g., social media, wikis, comments and discussions, etc.).

Conventional methods for monitoring brand performance typically involve one or more of the following techniques: (1) sampling and polling; (2) tracking visitors across multiple sites via server-side “beacons” on web servers; (3) monitoring which sites users access and when via client-side toolbars and reporting software (commonly known as “spyware”); (4) tracking users via cookies and IP addresses; (5) creating “panels” of prospective users via sampling and/or client-side toolbars; and (6) surveying publicly available social media data sources (e.g., Twitter, Facebook, etc.). The foregoing techniques, however, have numerous drawbacks.

Sampling and polling can be expensive due to the largely manual nature of the process, and presents a significant selection bias (i.e., people agreeing to participate in a survey are often not the people the media is trying to reach). Sampling and polling may be conducted based on recall, which may not be based on actual occurrences but rather what the audience remembers, thus making it difficult to obtain a demographically representative sample large or specific enough for statistically significant results.

Server-side beacons allow cross-site tracking of users, including users on mobile devices. However, such tracking only occurs on sites that have the beacon installed with a vast portion of the Internet not being covered by beacons. Moreover, cross-site movement data is not available due to privacy implications, which further limits the usefulness of server-side beacons.

Client-side toolbars allow full cross-site tracking of users in a way consistent with legal requirements for preservation of user privacy. However, these toolbars have a highly limited number of users and cannot track user actions on mobile devices, nor do they support all web browsing software (e.g., Alexa is only functional on computers but not on mobile devices). Furthermore, tracking all web sites visited by a user in order to form an impression of a web site audience is (while conforming to the letter of the law) ethically questionable and, thus, limits voluntary user participation.

Client-side cookies (especially those placed by ad networks) allow cross-site tracking of a single device (e.g., a computing device). Cross-site tracking data can be used by analytics companies, such as Nielsen, to monitor cross-site visits, however such tracking is panel based. Ad networks utilize cookie tracking data to serve the ads to an audience, but do not make it available for other purposes. For example, if an ad network placed a cookie, the cookie data is used to serve their clients' ads, and if the ad network purchased retargeting data from a vendor, such data is used to serve ads for their clients. The majority of cookies only track general information, such as the URL the user had visited, time spent, or number of pages viewed, but not detailed data such as what users commented on. Most web sites will not let a third party cookie collect detailed user behavior unless it is from Google Analytics or Omniture, where the web site owners are tracking what the users are doing on their sites.

Browser-based techniques may be unable to track mobile users that consume information via native apps, which constitute a majority of mobile users.

IP-based tracking can be used for tracking of a single computer or mobile device on a static network. However, this technique can be considered obsolete by increasing use of laptops, tablets, mobile devices that change their IP address often.

Social media listening or monitoring tools allow their users to ascertain the number of mentions of the tracked keywords and what is being talked about. Such techniques, however, present a largely qualitative view on the data and have little or no connection to the aforementioned monitoring techniques. These tools do not provide adequate analysis to understand the relationships between social media and web content exposure in a quantitative actionable manner. For example, suppose a brand has the following metrics:

| | Mentions | Reach | Engagements |
|---|---|---|---|
| Social | 5,000 | 10,000 | 500 |
| Web Article | 25 | 35,000,000 | 6,000 |
| Total | 5,025 | 35,010,000 | 6,500 |

Social monitoring techniques may report that the brand had 5,000 mentions and reached 10,000 people with 500 engagements, but fail to account for the bigger picture of audience size from the web article. In addition, such social monitoring techniques fail to draw relationships between the social posts and the content to which the social posts refer.

Due to limitations of the above techniques, they are often combined to achieve statistically sound “panels” of users which are then used as a representative sample of the entire audience.

While the sampling techniques have largely not evolved in the recent decades, the digital landscape has changed considerably. A number of digital trends have emerged that are rendering old techniques irrelevant, such as the emergence of social media (Twitter, Facebook, etc.) as primary sources of information for many consumers, the switch to non-linear media consumption (i.e., short video clips shared socially rather than passive television-watching), the reliance of publisher web content on social sharing as a means to drive exposure for their content, and the prevalence of mobile information consumption via smartphones and tablets.

Understanding the temporal component of brand and content placement is currently more qualitative than quantitative. Brand managers and publishers may expect that, for example, releasing a certain piece of content on a Friday afternoon might lead to low engagement rates, while another piece of content released at the same time might do well. The decision to time releases is usually made along the following lines of reasoning: “this content appeals to people working in offices, who frequently view it at work, therefore it must be released during working hours on a weekday” or “this content appeals to people at home”. However, the decisions themselves are made based on personal experience rather than quantitative data. Some current technologies attempt to address this problem. For example, Nielsen rates both content and time-slot performance for linear television using sampling panels and surveys. However, the time-slot performance does not extend to their monitoring products online. As another example, Radian6 and other social listening tools provide a metric of volume of messages coming in over time, but do not separate messages by reach, exposure, and engagement over time to relate social impact to the web content that may have started viral engagements.

A key difficulty in mapping performance of media and marketing materials lies in the fact that some online materials are streaming and time-sensitive while others are published on a more traditional model, with the two models coexisting freely. For example, content in a traditional magazine can be posted online and remain online for several weeks before being discovered on social media and widely “retweeted” and shared. A goal of a media manager or brand manager, then, is to minimize the time between publication of content on a site and achieving reach and exposure over streaming and user-generated media (such as social media). To achieve such analytics, it would be advantageous to utilize data from all relevant sources, not just social media sources.

A viral cascade is a sequence of events when one user of a social site (e.g. Twitter, Facebook, etc.) receives a link to a content, and shares it with his or her friends, some of whom proceed to share the content further, resulting potentially in exponential growth of the number of exposures the content receives. When a content item (e.g., video, advertisement, content, etc.) goes viral (i.e., transitions from slow and linear growth of number of readers to exponential growth), its exposure versus time may take the form of the curve shown in FIG. 1, referred to as a “diffusion curve” (see Diffusion of Innovations, Everett Rogers, 1995, pp. 262, 314).

Viral growth curve rarely starts at the time the content item is authored or publicly released. More often, the content item is published some time before it is discovered and starts to be reposted in a viral fashion. Moreover, over time it has become clear that viral distribution is not a one-shot occurrence, but often occurs in many ladder-steps. Current methods for tracking such viral growth are rather crude, as they mainly rely on volume of views and reposts, as well as simple social metrics (e.g., number of followers) of re-posters to understand the dynamics of the cascade.

In a related work (see S. Goel, D. Watts, and D. Goldstein, “The Structure of Online Diffusion Networks”, in Proceedings of the 13th ACM Conference on Electronic Commerce (EC 2012), 2012), viral cascades were tracked across Twitter by looking at occurrences of specific short uniform resource locators (URLs). It was determined that as many as 99% of viral cascades are not cascade-like but instead frequently consist of two or three people. This work determined that size of cascades follows a power law distribution, which is not unexpected as the number of followers each Twitter user has also follows the same distribution. However, this work suffers from a number of notable shortcomings that hinder its use in practice. For example, only shortened URLs were considered, which, while significantly simplifying the analysis, neglects the fact that the same content may be referred to by many (as many as tens of thousands) short URLs. Furthermore, as content is moved by users from one social platform to another, the short URLs change as well, thus resulting in a very truncated view of the social sharing dynamics.

Tracking information to its origin, namely an original content item (e.g., news content, blog post, etc.) requires relational monitoring of reposting, commenting, and links to the original content item. Current systems consider only a short snapshot of the social universe in time. It is known that much of the viral content is not instantly viral, and that many pieces of content may languish for months before being discovered and shared virally, thus requiring a larger time snapshot.

### BRIEF DESCRIPTION OF THE DRAWINGS

The embodiments of the present disclosure are illustrated by way of example, and not by way of limitation, and will become apparent upon consideration of the following description of the invention, taken in conjunction with the accompanying drawings, in which:

FIG. 1 is a plot of a diffusion curve illustrating content exposure versus time;

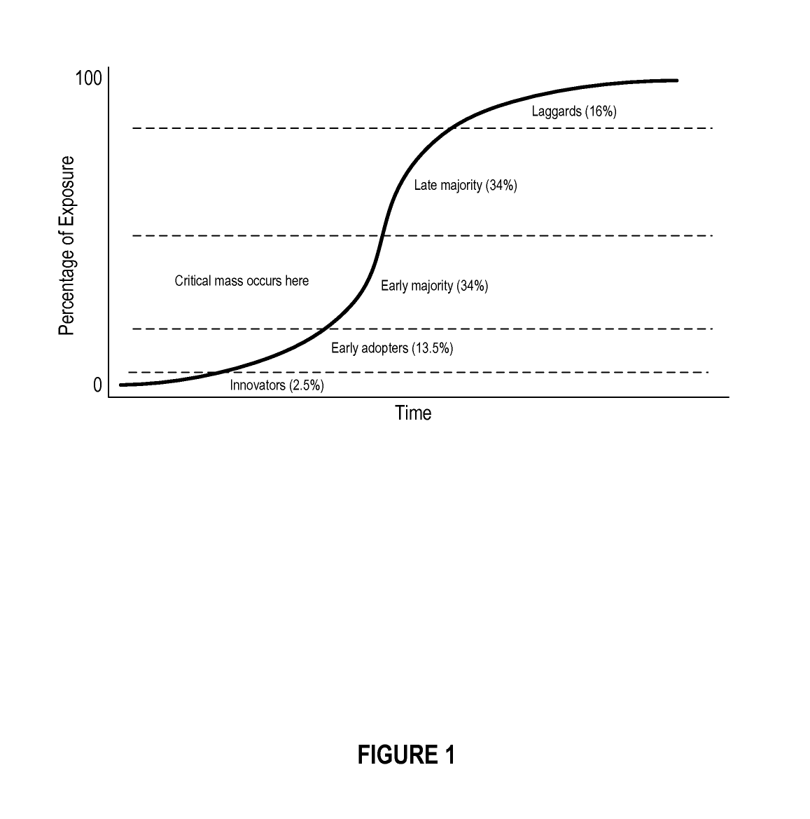

FIG. 2A illustrates an example system architecture in which embodiments of the present disclosure may operate;

FIG. 2B is a block diagram illustrating a modular representation of a data pipeline in accordance with an embodiment of the present disclosure;

FIG. 3 is a block diagram illustrating a system architecture for data ingestion in accordance with an embodiment of the present disclosure;

FIG. 4 illustrates a user interface for an exemplary Digital Prime-Time report in accordance with an embodiment of the present disclosure;

FIG. 5 illustrates a user interface for an exemplary message diffusion report in accordance with an embodiment of the present disclosure;

FIG. 6 illustrates a user interface for an exemplary exposure report in accordance with an embodiment of the present disclosure;

FIG. 7 is a flow diagram illustrating a method for processing data to monitor brand performance in accordance with an embodiment of the disclosure; and

FIG. 8 is a block diagram illustrating an exemplary computer system in accordance with an embodiment of the disclosure.

### DESCRIPTION OF THE INVENTION

The embodiments of the present disclosure relate to a system and method for measuring and analyzing, in real time, exposure, marketing reach, and engagement of a brand across content sources of the World Wide Web, including web sites and social media channels, in an integrated fashion (i.e., relationships between content and social mentions of the content are identified and utilized). Such embodiments may operate regardless of the device used to engage with the message—so long the engagement is published on the Internet, it can be collected and integrated. Certain embodiments are focused on “all-source” analytics, wherein multiple independent sources of data are ingested, translated into a consistent format, filtered, and presented in a single platform as a report or a single data stream. While the embodiments are described in the context of analyzing of online content, the embodiments can be extended to encompass other sources of data, including customer-owned CRM (customer relationship management) data, transaction streams, and application usage data (e.g., mobile app usage data).

A need has arisen for an analytics tool that integrates and analyzes brand exposure in an all-source, all-audience manner enabling prioritization of tactics based on potential exposure using metrics such as engagement, sentiment, geographical location, gender, and reach, as well as temporal reasoning and structural analysis of viral cascades. To address the temporal analysis needs, a concept referred to herein as “Digital Prime-Time” is encompassed in various embodiments, which allows for the measurement and analysis (in real-time, near real-time, or archived data over time) of amount of exposure, engagement, and reach across a wide variety of digital channels (i.e., content sources) available via the World Wide Web, including web sites and social media channels, in an integrated fashion for a brand, topic, or person. The data collected may be aggregated to build identify and visualize temporal patterns that drive exposure, engagement, and reach. A temporal pattern display, referred to herein as a Digital Prime-Time report, may be generated to allow a user to ascertain the exposure, engagement, and reach pattern for any given period (e.g., the time of day a brand receives the most reach, engagement, exposure, and speed and/or acceleration of the change (e.g. growth or topic) in order to determine when and where a certain type of content, brand, or topic can achieve greater popularity or faster distribution to a large audience. The Digital Prime-Time report measures the times when audiences are engaged with brand(s), topic(s), or keyword(s), where are they engaging (e.g., on Twitter or on the web site), and what is the size of audience exposure during that time. The Digital Prime Time further allows the user to learn how timing of release affects sentiment and perception by the recipients. Such embodiments may assist a marketer or brand manager in timing the release of content, media, social posts, advertising, or products to achieve the greatest impact. The Digital Prime-Time report may also be configured to allow the user to monitor performance of their owned-and-operated touch points (e.g., corporate web site or a social media page) against performance of their competitors. Such temporal analysis can also reveal how a viral message can travel from one content source to another (e.g., from CNN.com to Twitter, then to Facebook, then to NYTimes.com, then to Tumblr, etc.), thus allowing for strategic release of content or messages over time.

One of the difficulties of temporal tracking of content is the fact that many content items achieve engagement, reach, and popularity long after they have been originally posted, published, or otherwise made available for consumption. Thus, in many cases, attributing popularity numbers to current viral content results in a misleading analysis (e.g., a tweet that has 50,000 retweets may currently be considered viral, but if the tweet links to or refers to an original article on WSJ.com, then it is WSJ.com article that is viral and not the tweet). To address this difficulty, a concept referred to herein as a “Digital Cascade” is encompassed in various embodiments, which allows for analysis of information diffusion and the social structure of viral dissemination of content. A Digital Cascade report allows a user to track pathways that shared information takes through multiple digital channels (for both social and web sites) to determine the origin, breadth, and velocity of the spread of information. Identifying information sources and multipliers may allow users to optimize their digital targeting strategy. Furthermore, the corresponding data may allow users to track the original source (e.g., the web site, the writer, the person that posted on Twitter, etc.) of a specific content item, topic, or link, thus allow for the identification of active content creators as well as multipliers. In some embodiments, the Digital Cascade Report focuses on key cascade paths based on exposure and engagement patterns, thus eliminating tiny clusters of impact. For example, if a tweet reaches 5 people with no engagement, the impact may be determined to be too small to effect a business, and thus will be eliminated from display in the resulting report.

A common challenge faced by media planners is the selection of digital media placement (e.g., ad networks, social, mobile, etc.) to purchase advertising media to reach a certain sized audience with a certain number of impressions in certain geographical areas (e.g., 1 million people in the northeast U.S.) while achieving the maximum response from target consumers. Currently, the media planners buy the advertising based on the audience size of the touch point (e.g. web site, mobile app, etc.), but there is no guarantee that because NY Times may have females from ages 28-34 that they are engaging with or reading upon topics relevant to the brand—it is only known that these demographics are present. Engagement, reach, and exposure data made accessible by the embodiments of the present disclosure allows for this problem to be solved quantitatively by aggregating expected exposure and engagement by channel (e.g., web sites, social or mobile channels, etc.) and topic, and stratifying it geographically and demographically (where requisite data is available). For example, if it is determined that fly fishermen are tweeting articles, sharing tips, and engaged with social posts at 5 AM to 6 AM, a media planner may purchase more ads around that time and have CNN (from whom ad space was purchased) post the ads its social channels around that time. In addition to projecting the best selection of sites, a media target dashboard may be generated to display the path of maximum impact by showing the variable engagement and reach potential via cascade effects (e.g. by Digital Prime Time) to be at the right place at the right time and in the right mindset.

Thus, the embodiments of the present disclosure provide several advantages, including (1) an all-source, all-audience quantitative analysis of brand image, media exposure, engagement, geographical location, and sentiment for use by marketing professionals and brand managers; (2) providing the all-source, all-audience quantitative analysis in a cost-effective, software-as-a-service manner that minimizes the amount of time and resources required by users to invest in accessing the service; (3) providing an analytical framework that can be extended to operate on multiple disparate data sources, including client-proprietary data and open data; and (4) expanding quantitative monitoring into a large number of fields (e.g., public relations and military information support operations).

Certain embodiments can track how virality travels across content sources without the use of cookies by taking into account timestamps of originating content. For example, suppose an article is published on CNN on Aug. 1, 2014, and goes viral on Facebook and Twitter on Aug. 3, 2014. Such embodiments can determine that the article was first shared on Facebook on Aug. 2, 2014 at 12:45 PM ET with various engagements occurring afterwards, followed by the article being tweeted on Aug. 2, 2014 at 8 PM, with the article gaining significant momentum in terms of reach and exposure on both content sources some time thereafter. As another example, a large number of engagements for a Tumblr post on a certain musician may be traced back to the article, video, or Tumblr post that was published a year ago. By identifying and tracing back how a message started or a topic started, the embodiments described herein are able to show the behavior of how the message/topic can be spread to content viewers/consumers in a viral fashion, with the number of engagements becoming an indicator of a number of people that have processed the message and read it.

As used herein, the term “exposure” refers to a sum of web site audience, social account reach (such as Twitter followers, Facebook page likes, etc.), and/or other audience quantifying numbers (such as mobile app install base) without applying factors to de-duplicate the possible overlap of users that may have been reached throughout all channels/content sources. For example, a user who commented on an article on CNN.com, retweeted CNN's tweet, and reblogged CNN's post on Tumblr would be counted 3 times in computing the overall exposure.

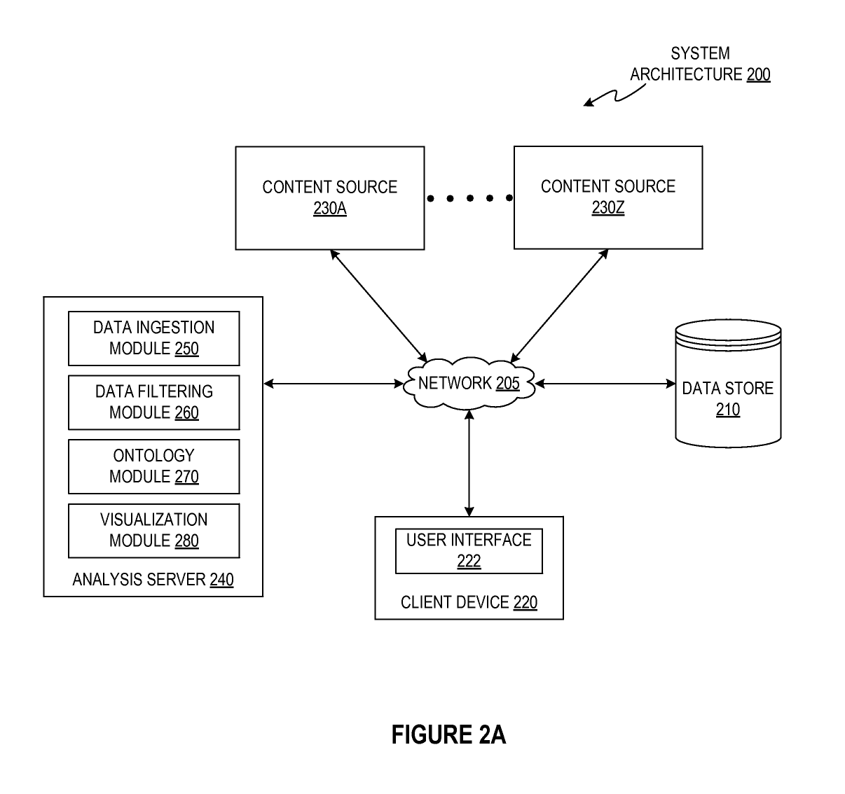

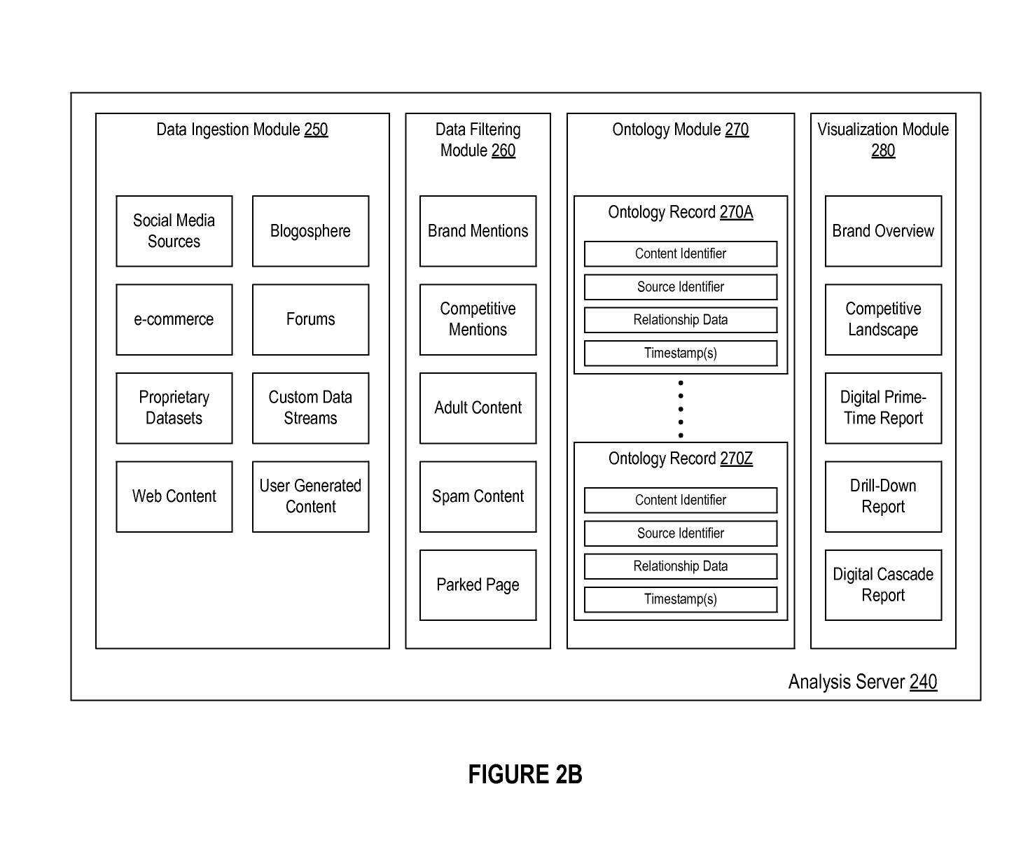

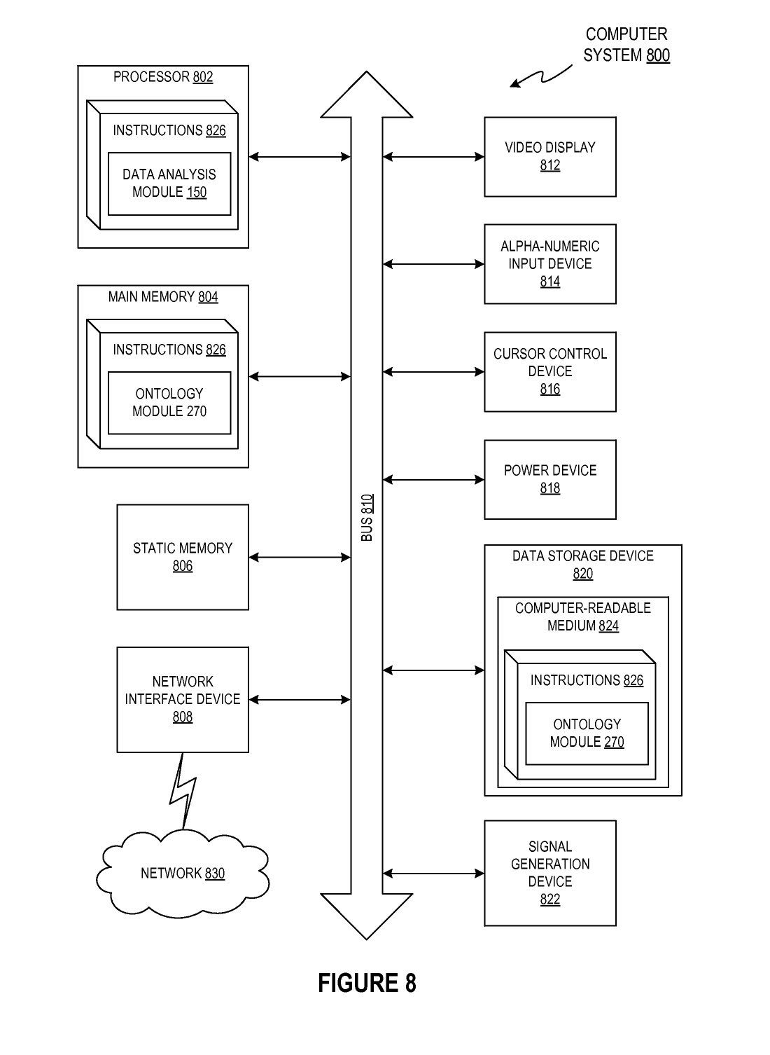

FIG. 2A illustrates an example system architecture 200 architecture in which embodiments of the present disclosure may operate. The system architecture 200 includes a data store 210, client device 220, content sources 230A-230Z, and an analysis server 240, with each device of the system architecture 200 being communicatively coupled via a network 205. One or more of the devices of the system architecture 200 may be implemented using computer system 800, described below with respect to FIG. 8.

In one embodiment, network 205 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. Although the network 205 is depicted as a single network, the network 205 may include one or more networks operating as a stand-alone networks or in cooperation with each other. The network 205 may utilize one or more protocols of one or more devices to which they are communicatively coupled. The network 205 may translate to or from other protocols to one or more protocols of network devices.

In one embodiment, the data store 210 may be a memory (e.g., random access memory), a cache, a drive (e.g., a hard drive), a flash drive, a database system, or another type of component or device capable of storing data. The data store 210 may also include multiple storage components (e.g., multiple drives or multiple databases) that may also span multiple computing devices (e.g., multiple server computers). In some embodiments, the data store 210 may be cloud-based. One or more of the devices of system architecture 200 may utilize their own storage and/or the data store 210 to store public and private data, and the data store 210 may configured to provide secure storage for private data. In some embodiments, the data store 210 for data back-up or archival purposes.

The client device 220 may be a computing device such as personal computer (PC), laptop, mobile phone, smart phone, tablet computer, netbook computer, smart TV, etc. Client device 220 may also be referred to as a “user device” or “mobile device”. An individual user may be associated with (e.g., own and/or use) the client device 220. The client device 220 may be owned and utilized by different users at different locations. As used herein, a “user” may be represented as a single individual. However, other embodiments of the disclosure encompass a “user” being an entity controlled by a set of users and/or an automated source. For example, a set of individual users federated as a community in a company or government organization may be considered a “user”.

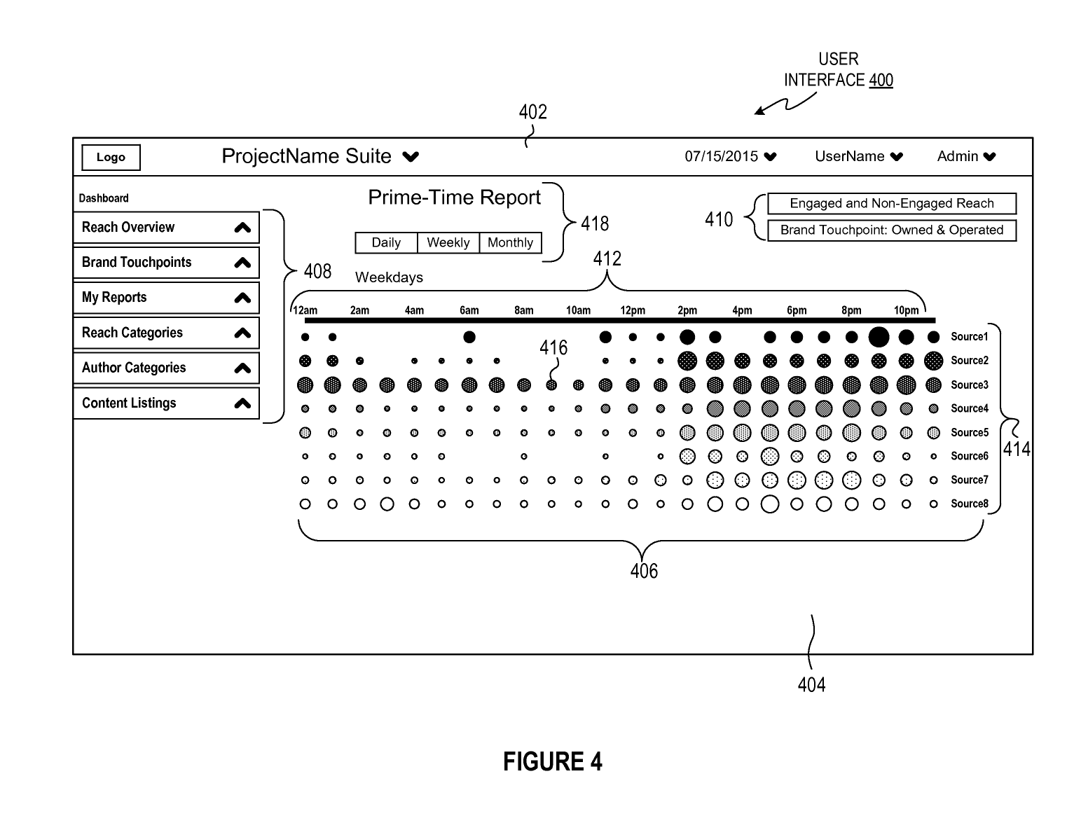

The client device 220 implements a user interface 222, which may allow the user of the client device 220 to send/receive information to/from the data store 210, one or more of the content sources 230A-230Z, the analysis server 240, or other servers or client devices. For example, the user interface 222 may be a web browser interface that can access, retrieve, present, and/or navigate content (e.g., web pages such as Hyper Text Markup Language (HTML) pages) provided by the analysis server 240. As another example, the user interface 222 may enable data visualization by the client device 220. In one embodiment, the user interface 222 may be a standalone application (e.g., a mobile “app”, etc.), that allows the user of the client device 220 to send/receive information to/from the data store 210, one or more of the content sources 230A-230Z, the analysis server 230, or other servers or client devices. FIGS. 4-6, which are discussed in greater detail below, show examples of user interfaces for monitoring brand performance that may be implemented by the client device 220.

In one embodiment, the content sources 230A-230Z may each be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components from which content items and metadata may be retrieved/aggregated. In some embodiments, one or more of the content sources 230A-230Z may be a server utilized by the client device 220 or the analysis server 240 to retrieve/access content or information pertaining to content (e.g., content metadata).

In some embodiments, the content sources 230A-230Z may serve as sources of content that can be provided to any of the devices of the system architecture 200. The content sources 230A-230Z may host various types of content items, including, but not limited to, online content, online news content, personal web pages, business web pages, encyclopedia content (e.g., Wikipedia pages), online forums (including threads, topics, and individual messages), video content, audio content (e.g., podcasts), blog posts, social media pages, images, and social media messages (e.g., “tweets”). In some embodiments, the content sources 230A-230Z may specialize in particular types of content (e.g., a first content server that hosts video content, another content server that hosts online content, etc.). In some embodiments, one or more of the content sources 230A-230Z may host shared content, private content (e.g., content restricted to use by a single user or a group of users), commercially distributable content, etc. In some embodiments, one or more of the content sources 230A-230Z may maintain content databases, which can include records of content titles, descriptions, keywords, cross-references to related content or associated content, metadata describing edits or updates to the content, and user account data.

In one embodiment, the analysis server 240 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to aggregate and ingest data from the content sources 230A-230Z (e.g., using data ingestion module 250), filter the data (e.g., using data filtering module 260), analyze and organize the data (e.g., using ontology module 270), and prepare the data for visualization by the client device 220 (e.g., using visualization module 280).

The functionality of the analysis server and its various modules is now described with reference to FIG. 2B, which is a block diagram illustrating a modular representation of a data pipeline from initial data ingestion to user interface presentation in accordance with an embodiment of the present disclosure.

In one embodiment, the data ingestion module 250 aggregates and ingests data from a variety of content sources (e.g., the content sources 230A-230Z), with the aggregated data containing content items (e.g., web documents, videos, podcasts, etc.) and/or descriptions of content items (e.g., metadata, titles, summaries, URLs that link to the content items, etc.). The content sources may include online sources such as social media sources (e.g., Twitter, Facebook, Tumblr, etc.), content from blogs, e-commerce sites (including stock keeping unit (SKU) data for level analysis of online content), forums, proprietary datasets, custom data streams, web content (e.g., media sites, Wikipedia content, updates and publication of pages to static web sites, and user generated content. In some embodiments, the data ingestion module 250 may absorb data in real time (e.g., at a rate over 200 GB per hour). In some embodiments, the data ingestion module 250 may utilize statistical sampling technologies, server-side beacons, and/or client-side beacons. In other embodiments, the data ingestion module 250 may directly receive all data from online sources rather than utilize statistical sampling or beacons, which may allow data to be collected and analyzed on competitive landscape of client's brands and media sources.

In some embodiments, the data filtering module 260 may be utilized to remove irrelevant content items or references thereto from the aggregated data. Filters may be used to identify or tag content items based on categories, such as undesirable content (e.g., adult content, spam content, parked pages, blacklisted sites such as known sites containing viruses or malware, etc.), product or corporate sites, forums, and Wikipedia content, and user-generated content.

In some embodiments, multiple filtering steps may be performed. For example, undesirable content items may be removed, followed by identifying content items related to a brand identifier (e.g., a brand name, a business name, a product name, a service name, a mascot name, a celebrity name, a motto, a mission statement, or a logo image) and removal of content items unrelated to the brand identifier. In some embodiments, content items may be removed if one or more data criteria not met, such as engagement activity (e.g., reposts, retweets, comments by content viewers, etc.) associated with the content item being below a threshold level of activity. For example, a product review that has been reposted less than 5 times may be filtered out, as such content may not be useful in gauging the product's popularity. In some embodiments, content filtering may be performed by identifying competitive mentions of the brand in order to evaluate the competitive landscape surrounding the brand.

In some embodiments, incoming content may be tagged with a sentiment score (e.g., a negative to positive score) indicative of sentiment toward the brand by the content item (e.g., a high positive score indicates a positive review of the brand or product associated with the brand). In some embodiments, natural language processing (NLP) may be utilized to extract key terms and phrases from the content item in order to compute a sentiment score. In some embodiments, the content item may be tagged with a sentiment score by an editor. In some embodiments, one or more of sentiment score, geographical location, or gender may be extracted from a rating associated with a content item (e.g., if the content item includes a product rating, such as from 1 star to 5 stars, the sentiment score may be computed from the product rating and normalized as appropriate).

In some embodiments, the ontology module 270 allows for aggregated data collected from various data sources to be converted into a format that can be analyzed in a consistent manner. The fact that data comes in a variety of diverse formats has posed a problem for conventional methods. The embodiments described herein provide a mechanism for casting data from disparate data sources into a consistent ontology that enables analysis of all data sources alongside each other. As used herein, the term “ontology” refers to a standardized collection of data items and relationships that may be used to describe data from various sources in a unified fashion.

In some embodiments, the ontology module 270 may generate ontology records 270A-270Z from the filtered data. Each of the ontology records 270A-270Z may correspond to a particular content item of the aggregated data, and include a content identifier (e.g., a reference to the content item such as a title, a URL, a unique identifier, etc.), a source identifier indicative of a source of the content items (e.g., one of the content sources 230A-230Z), relationship data indicative of one or more relationships between the content item and other content items (e.g., reposts by/of the content item, links to/from the content item, etc.), one or more timestamps (e.g., timestamps indicative of when the content item was originated or first available, when the content item was reposted, when the content item was updated, etc.), or other types of data or identifiers. In some embodiments, the elements of each of the ontology records 270A-270Z are extracted from the aggregated data (e.g., content identifiers, source identifiers, timestamps, etc.). In some embodiments, relationship data may be generated by the ontology module 270, for example, by comparing similarities between content items, links from one content item to another, reposts of one content item by another, etc.

In some embodiments, the visualization module 280 may utilize the ontological records 270A-270Z to generate visualization data for display by a client device (e.g., the client device 220). The generated visualization data may be used to generate, for example, a media target dashboard including brand overview and competitive landscape information, a temporal analysis report (Digital Prime-Time report), an information diffusion or proximity report (Digital Cascade report), a drill-down report, or other type of graphical user interface. Exemplary user interfaces are described below with respect to FIGS. 4-6.

Although each of the data store 210, the client device 220, the content sources 230A-230Z, and the analysis server 240 are depicted in FIG. 2A as single, disparate components, these components may be implemented together in a single device or networked in various combinations of multiple different devices that operate together. In some embodiments, some or all of the functionality of the analysis server 240 may be performed in conjunction with multiple devices (e.g., additional servers, client devices, etc.). For example, the client device 220 may implement a software application that performs the functions of one or more of the data ingestion module 250, the data filtering module 260, the ontology module 270, or the visualization module 280. In some embodiments, one or more of the modules of the analysis server 240 may be hosted on or executed by different devices.

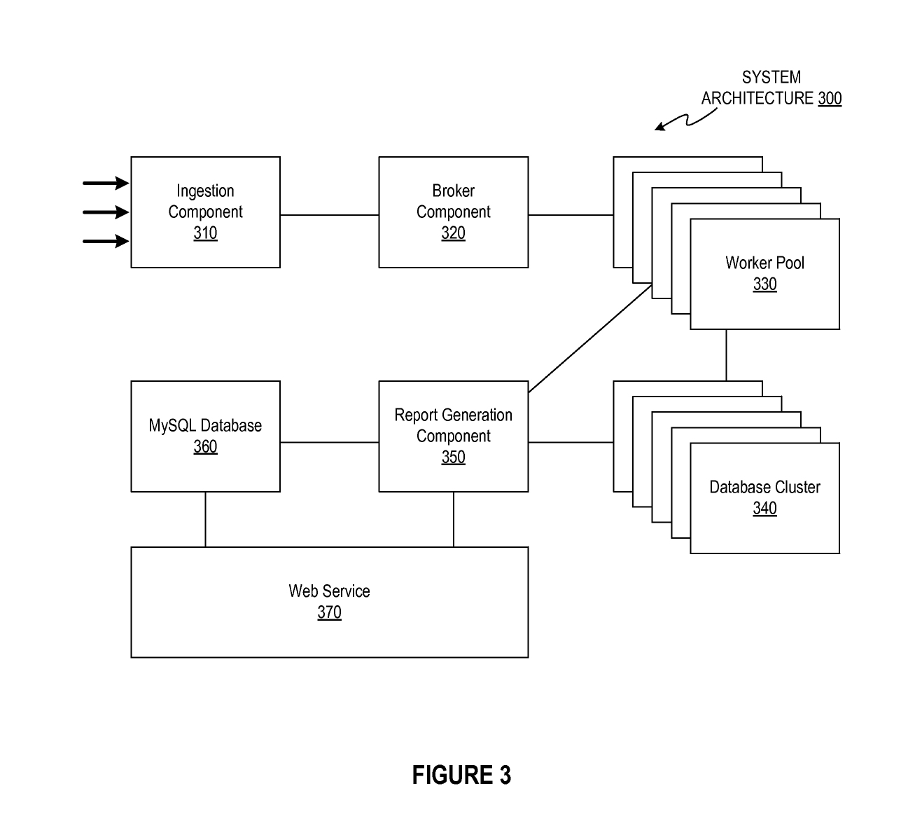

FIG. 3 is a block diagram illustrating a system architecture 300 for data ingestion in accordance with an embodiment of the present disclosure. In some embodiments, the functionality of the system architecture 300 is distributed among the data ingestion module 250, the data filtering module 260, the ontology module 270, and the visualization module 280. The ingestion component 310 may be configured to manage data acquisition from multiple sources including open APIs for major media services, content aggregation services, and web scraping services. The ingestion 310 component may be communicatively coupled to a broker component 320 that is configured to assign a piece of data received at the ingestion component 310 to a worker pool 330, wherein filtering, extraction, and preliminary analysis may be performed before loading the results into a database cluster 340 (e.g., a MongoDB distributed database cluster). A report generation component 350 may run a periodic batch job on data in the database cluster 340, and may utilize pre-computed reports that can be later accessed within a MySQL database 360 via a user interface through a web service 370. In some embodiments, reports can be pre-generated and/or generated in real-time or in near real-time. The user interface (e.g., the user interface 222) may be a user interface that provides a graphical representation of the data and allows users to select and browse various reports, as well as access the raw content stored in the database cluster 340.

FIGS. 4-6 illustrate exemplary user interfaces showing, respectively, a temporal analysis report (“Digital Prime-Time” report), a message diffusion report (Digital Cascade report), and an exposure report in accordance with embodiments of the present invention. In some embodiments, the visualization module 280 may be used to generate various reports and drill down functions, allowing users to view a top-level overview of their total media exposure and engagement, combining web content and social media exposure (as well as “web content via social media”) for a unique, fully integrated, analytics experience. Measurements include exposure (audience size), engagement (level of observed interaction with content), and sentiment (whether attention is negative or positive). Users may drill down into the data sources and analytics in depth, going from a top-level overview to individual pieces of content. Users may also filter data by engagement ratio, sentiment, and type of exposure (organic/owned).

FIG. 4 shows a user interface 400 illustrating an exemplary temporal analysis (Digital Prime-Time) report in accordance with an embodiment of the present disclosure. The user interface 400 includes a header portion 402 (e.g., which may include a project title, a service logo, and other labels and/or options) and a report window 404. The report window 404 includes prime-time report 406, dashboard options 408, and additional visualization options 410.

In some embodiments, the prime-time report 406 is presented as a two-dimensional grid organized according to a time axis 412 and a source axis 414. The visualization module 280 may identify ontology records (e.g., ontology records 270A-270Z) having associated timestamps that correspond to time durations represented by the time axis 412. The ontology records may further be identified based on associated content sources that correspond to content sources represented by the source axis 414 (e.g., Source1, Source2, etc.). Ontology records are grouped according to source and time, with visual elements being representative of reach/exposure data associated with the grouped ontology records. For example, visual element 416 may represent reach/exposure data for content items from Source3 having timestamps occurring between 9 am and 10 am on Jul. 15, 2015. A visual appearance of the elements in prime-time report 406 may be representative of computed quantities derived from the ontology records. A computed quantity may correspond to, for example, a total number of engagements (e.g., reports, links, retweets, etc.) for each content item of a time and source grouping. Accordingly, the prime-time report 406 may allow for brand managers to track brand popularity to according to time and source, accurately assess different exposure, response, and engagement related to the brand, and optimally time the release of digital content to achieve maximum impact across multiple media sources. Selection of dashboard options 408 and additional options 410 may allow for the generation of different reports, such as reports related to brand competitors and reports related to particular authors of content. Reports include the capability of drilling down and analyzing individual pieces of content, as well as the brand's exposure and engagement analysis from an all-source perspective.

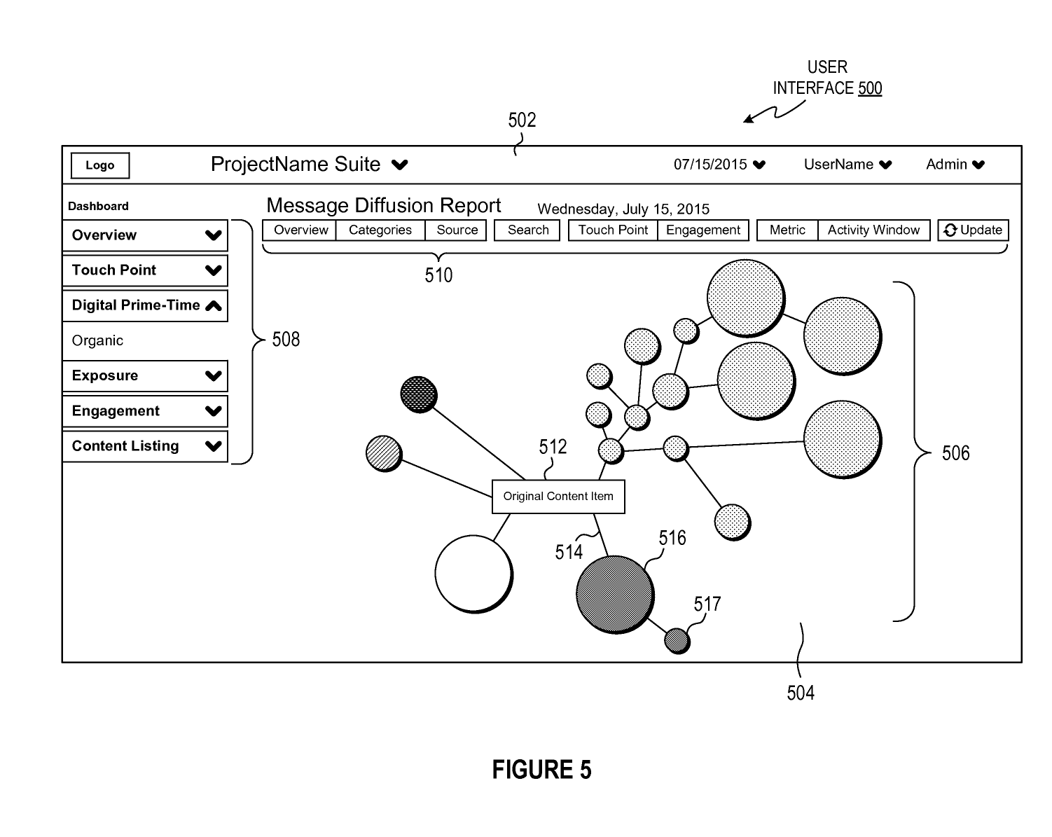

FIG. 5 illustrates a user interface 500 for an exemplary message diffusion (Digital Cascade) report in accordance with an embodiment of the present disclosure. The user interface 500 includes a header portion 502 (e.g., which may include a project title, a service logo, and other labels and/or options) and a report window 504. The report window 504 includes diffusion report 506, dashboard options 508, and additional visualization options 510.

The visualization module 280 may utilize ontology records (e.g., ontology records 270A-270Z) to identify original content items and/or track their engagement behavior over time. The visualization module 280 may also generate the diffusion report 506, which allows for the visualization of the original content item and its engagements (tweets, reposts, and comments) over time. Information related to the original content item may be tracked according based on various parameters, including, but not limited to, the original content item's original URL of publication (“permalink”), content title, and content. As contrasted with purely URL-based tracking, embodiments of the Digital Cascade report allows for sites with dynamic URL generation schemes to be tracked in the same manner as sites with static URLs.

In some embodiments, the diffusion report 506 includes representations of various content items, such as an original content item 512, content item 516 (which may represent an engagement of the original content item 512), and content item 517 (which may represent an engagement of content item 516), as well as relationship indicators between the various content items, such as relationship indicator 514. A plurality of digital cascade metrics may be employed in the analysis of message diffusion including, but not limited to, a message diffusion breadth, a message diffusion depth, a message diffusion velocity, and a message diffusion path, any of which may be graphically represented by the content items and/or relationship indicators. For example, sizes, shapes, colors, etc. of the content item representations may represent various metrics associated with the various content items (e.g., a larger circle may indicate higher rating, views, or associated comments for that content item than that of a smaller circle). Similarly, length, color, width, etc. of the relationship indicators may represent various metrics as well (e.g., a length of relationship indicator 514 may represent a time between a posting of the original content item 512 and a reposting as content item 516).

Message diffusion breadth can be based on engagement or exposure, and may be representative of a number of engagements (e.g. reposts, likes) from a single post (i.e., branching factor of the repost graph) over time or for specific time periods. Message diffusion depth may correspond to a length of the path a message takes from the original content item 512 over time or for specific time periods. Message diffusion velocity (in both breadth and depth) may characterize the speed of message spread over time or for specific time periods. Message diffusion path (in all measures of breadth, depth and velocity) may map the points of occurrence of breadth, depth, and velocity over time or for specific time periods. For example, a message posted by a celebrity may have significant exposure breadth (owing to the celebrity status of the poster) but little exposure depth and velocity. At the same time, content published by a niche may have lower breadth, but instead achieve significant depth and velocity as it proliferates. An optimal path of the highest velocity message diffusion can be identified from the origination of the original content item or at mid-point of the path through the message diffusion process. A selection of one or more of the dashboard options 508 and the additional visualization options 510 may alter the presentation of the diffusion report 506 to visualize different metrics. In addition, pattern and consistency by the touch point to the type of message can be assessed. For example, if a celebrity that wrote an article about a topic generated high breadth and depth in a single instance without demonstrating consistent success in discussing the topic matter, then the celebrity's content contribution may be excluded from the cascade report (i.e., inclusion in the cascade report includes a mixture of metric measures and patterns of the message behavior).

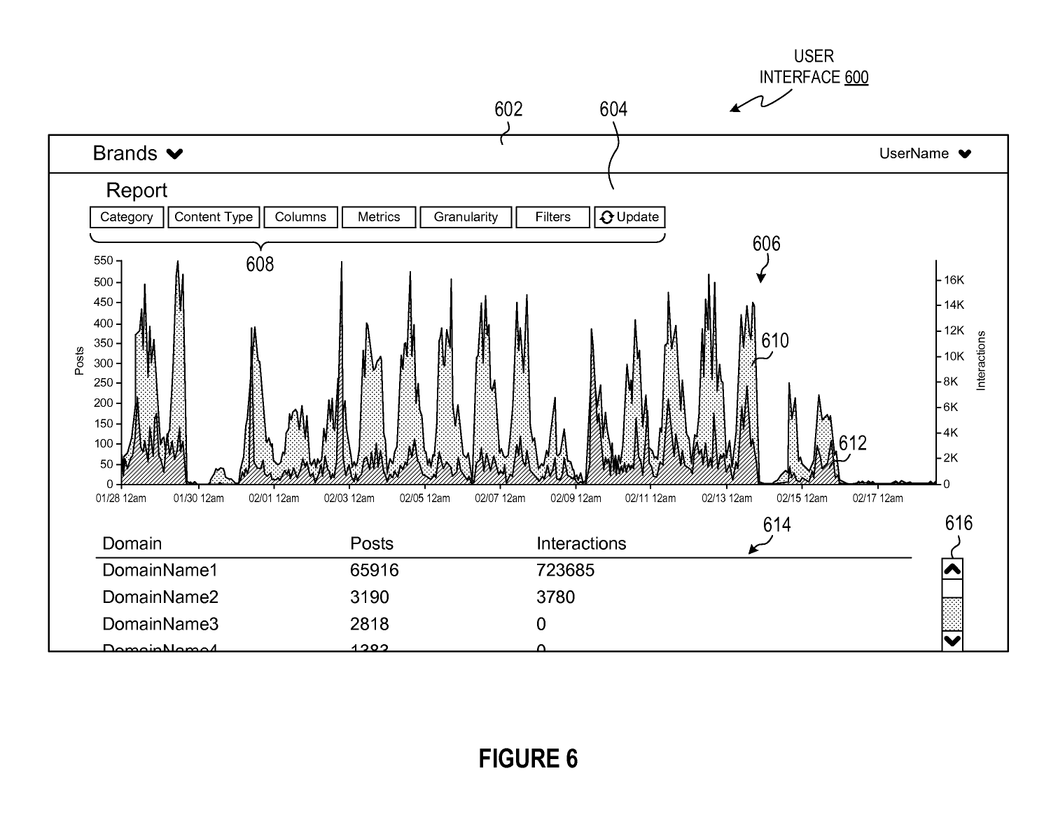

FIG. 6 illustrates a user interface 600 for an exemplary exposure report in accordance with an embodiment of the present disclosure. The user interface 600 includes a header portion 602 and a report window 604. The report window 604 includes analysis report 606, report options 608, and source engagement data 614 (which may include a scrollbar 616 to browse data). The analysis report 606 may include, for example, detailed engagement data related to a particular brand, such as postings 610 and interactions 612 over time for a particular time period. In some embodiments, the exposure report (or competitive analysis report) presents exposure analysis of the user's brand in the context of their competitor's media and marketing activity. The exposure report may display some or all competitor activities online including content publishing schedule on various content sources, uploading of the SKUs, comments from readers, engagements, etc. A proximity analysis analyzes linguistic context of the brands' mentions across media sources. A proximity analysis may determine what messages resonate with various audiences to tailor media exposure accordingly. It may also detect other brands that are clustered around a user's brand, including new brands that are entering the space.

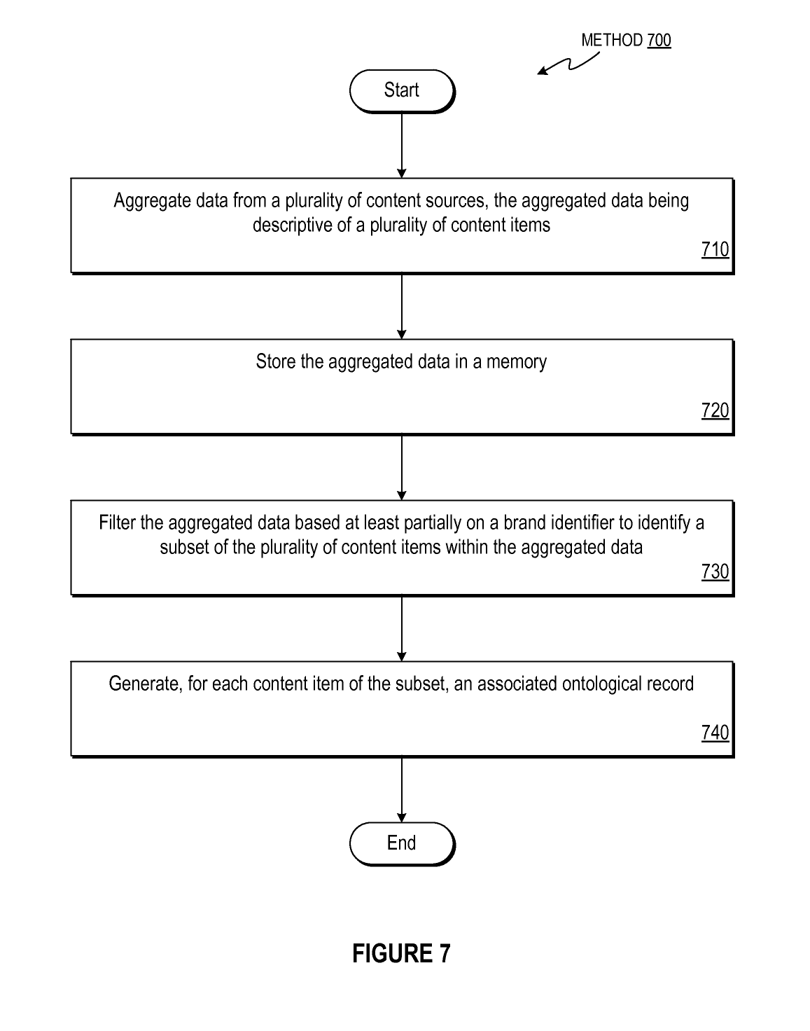

FIG. 7 is a flow diagram illustrating a method 700 for processing data to monitor brand performance in accordance with an embodiment of the disclosure. The method 700 may be performed by processing logic that includes hardware (e.g., circuitry, dedicated logic, programmable logic, microcode, etc.), software (e.g., instructions run on a processing device to perform hardware simulation), or a combination thereof. In one embodiment, the method 700 may be performed by a processing device executing one or more of the data ingestion module 250, the data filtering module 260, the ontology model 270, or the visualization module 280 described with respect to FIGS. 2A and 2B. In one embodiment, the method 700 is executed by a processing device of a server (e.g., the analysis server 240).

Referring to FIG. 7, at block 710, a processing device aggregates data from a plurality of content sources, and at block 720, the aggregated data may be stored in a memory (e.g., a memory communicatively coupled to the processing device, such as the data store 210). The aggregated data is descriptive of a plurality of content items. The plurality of content items may correspond to, for example, online content, online news content, personal web pages, business web pages, encyclopedia content (e.g., Wikipedia pages), online forums (including threads, topics, and individual messages), video content, audio content (e.g., podcasts), blog posts, social media pages, and social media messages (e.g., “tweets”), as well as engagements thereof (e.g., reposts, comments, etc.). The aggregated data may describe a content item, for example, by including information related to the content item (e.g., metadata) and a reference to a location of the content item (e.g., if the content item is a web page or is available via a web page). In some embodiments, the aggregated data may include the content item itself (e.g., the aggregated data may include a retrieved web page that includes the content item). In some embodiments, the processing device updates the aggregated data in real-time by retrieving additional data from the plurality of content sources.

At block 730, the processing device filters the aggregated data based at least partially on a brand identifier to identify a subset of the plurality of content items within the aggregated data. In some embodiments, the brand identifier includes one or more of a brand name, a business name, a product name, a service name, a mascot name, a celebrity name, a motto, a mission statement, a brand-related message, or a logo image. In some embodiments, the processing device filters the aggregated data by identifying content items having associated engagement activity that is below a threshold level of engagement activity, and excluding the identified content items from the subset of the plurality of content items.

At block 740, the processing device generates, for each content item of the subset, an associated ontological record (e.g., the ontology records 270A-270Z). Each ontological record includes, for example, an identifier of its associated content item, an identifier of an associated content source of the plurality of content sources from which the content item is sourced, and a descriptor of a relationship between the associated content item and one or more content items of the subset. In some embodiments, the descriptor of the relationship between the associated content item and the one or more items of the subset is an engagement activity (e.g., reposts, links, retweets, comments, etc.). For example, content item A may be a reposting of content item B, with the descriptor of the relationship being indicative of the reposting relationship between content items A and B.

In some embodiments, each ontological record further includes a timestamp corresponding to an origin of a content item associated with the ontological record. In some embodiments, for a given time duration of a plurality of time durations and a given content source of the plurality of content sources, the processing device computes a score or ranking based at least partially on one or more of exposure or engagement activities associated with content items that are sourced from the given content source and have associated timestamps that occur within the given time duration. The processing device may further generate temporal analysis data to be rendered for display by a display device. In some embodiments, the rendered display of the content diffusion data may be the same or similar to that of user interface 400 described with respect to FIG. 4, and include a grid (e.g., prime-time report 406) having a first axis representing an information metric (e.g., one or more of the plurality of content sources, such as source axis 414) and a second axis representing the plurality of time durations (e.g., time axis 412). In some embodiments, the first and second axes may each independently be representative of source, time durations, brand, content, content author, social influencer, content volume or engagement days of the week, number of web sites, number of influencers, posts per hour, or any other suitable metric. In some embodiments, one of the first or second axes may correspond to time durations while the other corresponds to any of the aforementioned metrics. The rendered display may also include visual representations of one or more of exposure, engagement, or a number of content items (e.g., visual elements such as visual element 416) arranged in the grid according to content sources and time durations (or according to axes representative of other metrics) associated with the exposure, engagement, or number of content items.

In some embodiments, the processing device identifies, from the ontological records, an original content item based on relationships between the original content item and one or more related content items of the subset. The processing device may further generate content diffusion data to be rendered for display by a display device. In some embodiments, the rendered display of the content diffusion data may be the same or similar to that of user interface 500 described with respect to FIG. 5, and include a visual representation of the original content item (e.g., original content item 512), visual representations of the one or more related content items (e.g., content items 516 and 517), and visual representations of relationships between any displayed visual representations of content items (e.g., relationship indicator 514).

For simplicity of explanation, the methods of the present disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture”, as used herein, is intended to encompass a computer program accessible from any computer-readable device or storage media.

FIG. 8 illustrates a diagrammatic representation of a machine in the exemplary form of a computer system 800 within which a set of instructions (e.g., for causing the machine to perform any one or more of the methodologies discussed herein) may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 800 may be utilized by or illustrative of any of the data store 210, the client device 220, one or more of the content sources 230A-230Z, and the analysis server 240.

The exemplary computer system 800 includes a processing device (processor) 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage device 820, which communicate with each other via a bus 810.

Processor 802 represents one or more general-purpose processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 802 may also be one or more special-purpose processing devices such as an application specific integrated circuit (ASIC), a field programmable gate array (FPGA), a digital signal processor (DSP), network processor, or the like. The processor 802 is configured to execute instructions 826 for performing the operations and steps discussed herein.

The computer system 800 may further include a network interface device 808. The computer system 800 also may include a video display unit 812 (e.g., a liquid crystal display (LCD), a cathode ray tube (CRT), or a touch screen), an alphanumeric input device 814 (e.g., a keyboard), a cursor control device 816 (e.g., a mouse), and a signal generation device 822 (e.g., a speaker).

Power device 818 may monitor a power level of a battery used to power the computer system 800 or one or more of its components. The power device 818 may provide one or more interfaces to provide an indication of a power level, a time window remaining prior to shutdown of computer system 800 or one or more of its components, a power consumption rate, an indicator of whether computer system is utilizing an external power source or battery power, and other power related information. In some embodiments, indications related to the power device 818 may be accessible remotely (e.g., accessible to a remote back-up management module via a network connection). In some embodiments, a battery utilized by the power device 818 may be an uninterruptable power supply (UPS) local to or remote from computer system 800. In such embodiments, the power device 818 may provide information about a power level of the UPS.

The data storage device 820 may include a computer-readable storage medium 824 on which is stored one or more sets of instructions 826 (e.g., software) embodying any one or more of the methodologies or functions described herein. The instructions 826 may also reside, completely or at least partially, within the main memory 804 and/or within the processor 802 during execution thereof by the computer system 800, the main memory 804 and the processor 802 also constituting computer-readable storage media. The instructions 826 may further be transmitted or received over a network 830 (e.g., the network 205) via the network interface device 808.

In one embodiment, the instructions 826 include instructions for one or more modules (e.g., the ontology module 270) which may correspond to any of the modules described with respect to FIGS. 2A and 2B. While the computer-readable storage medium 824 is shown in an exemplary embodiment to be a single medium, the terms “computer-readable storage medium” or “machine-readable storage medium” should be taken to include a single medium or multiple media (e.g., a centralized or distributed database, and/or associated caches and servers) that store the one or more sets of instructions. The terms “computer-readable storage medium” or “machine-readable storage medium” shall also be taken to include any transitory or non-transitory medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is herein, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “receiving”, “retrieving”, “transmitting”, “computing”, “generating”, “adding”, “subtracting”, “multiplying”, “dividing”, “optimizing”, “calibrating”, “detecting”, “performing”, “analyzing”, “determining”, “enabling”, “identifying”, “modifying”, “aggregating”, “storing”, “rendering”, “presenting”, “filtering”, “updating”, “including”, “excluding”, “displaying”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus, device, or system for performing the operations herein. This apparatus, device, or system may be specially constructed for the required purposes, or it may include a general purpose computer selectively activated or reconfigured by a computer program stored in the computer. Such a computer program may be stored in a computer- or machine-readable storage medium, such as, but not limited to, any type of disk including floppy disks, optical disks, compact disk read-only memories (CD-ROMs), and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an embodiment” or “one embodiment” means that a particular feature, structure, or characteristic described in connection with the embodiment is included in at least one embodiment. Thus, the appearances of the phrase “an embodiment” or “one embodiment” in various places throughout this specification are not necessarily all referring to the same embodiment. Moreover, it is noted that the “A-Z” notation used in reference to certain elements of the drawings is not intended to be limiting to a particular number of elements. Thus, “A-Z” is to be construed as having one or more of the element present in a particular embodiment.

The present disclosure is not to be limited in scope by the specific embodiments described herein or by way of illustration in the accompanying drawings. Indeed, other various embodiments of and modifications to the present disclosure pertaining to the monitoring of brand performance, in addition to those described herein, will be apparent to those of ordinary skill in the art from the preceding description and accompanying drawings. Thus, such other embodiments and modifications pertaining to the monitoring of brand performance are intended to fall within the scope of the present disclosure. Further, although the present disclosure has been described herein in the context of a particular embodiment in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

What is claimed is:

1. A method comprising:
aggregating, by a processing device, data from a plurality of content sources, the aggregated data being descriptive of a plurality of content items;
storing, by the processing device, the aggregated data in a memory;
filtering, by the processing device, the aggregated data based at least partially on a brand identifier to identify a subset of the plurality of content items within the aggregated data; and
generating, by the processing device for each content item of the subset, an associated ontological record, each ontological record comprising an identifier of its associated content item, an identifier of an associated content source of the plurality of content sources from which the content item is sourced, and a descriptor of a relationship between the associated content item and one or more content items of the subset.

2. The method of claim 1, wherein the descriptor of the relationship between the associated content item and the one or more items of the subset is an engagement activity.

3. The method of claim 2, wherein each ontological record further comprises a timestamp corresponding to an origin of a content item associated with the ontological record, and wherein the method further comprises:
for a given time duration of a plurality of time durations and a given content source of the plurality of content sources:
computing a score or ranking based at least partially on one or more of exposure or engagement activities associated with content items that are sourced from the given content source and have associated timestamps that occur within the given time duration.

4. The method of claim 3, further comprising:
generating temporal analysis data to be rendered for display by a display device, wherein a rendered display of the content diffusion data comprises:
a grid having a first axis representing an information metric and a second axis representing the plurality of time durations; and
visual representations of one or more of exposure, engagement, or number of content items arranged in the grid according to content sources and time durations associated with the exposure, engagement, or number of items.

5. The method of claim 1, further comprising:
identifying, from the ontological records, an original content item based on relationships between the original content item and one or more related content items or content items of the subset.

6. The method of claim 4, further comprising:
generating content diffusion data to be rendered for display by a display device, wherein a rendered display of the content diffusion data comprises a visual representation of the original content item, visual representations of the one or more related content items, and visual representations of relationships between any displayed visual representations of content items.

7. The method of claim 1, wherein filtering the aggregated data based at least partially on the brand identifier further comprises:
identifying content items having associated engagement or exposure activity that is below a threshold level of engagement or exposure activity; and
excluding the identified content items from the subset of the plurality of content items.

8. The method of claim 1, wherein the brand identifier comprises one or more of a brand name, a business name, a product name, a service name, a mascot name, a celebrity name, a motto, a mission statement, a brand-related message, or a logo image.

9. The method of claim 1, wherein each of the plurality of content items is selected from a group consisting of online content, online news content, a personal web page, a business web page, online encyclopedia content, an forum thread, a forum topic, a forum message, video content, audio content, a blog post, a social media page, and a social media message.

10. The method of claim 1, further comprising:
updating the aggregated data in real-time.

11. A system comprising:
a memory; and
a processing device communicatively coupled to the memory, wherein the processing device is to:
aggregate data from a plurality of content sources, the aggregated data being descriptive of a plurality of content items;
store the aggregated data in the memory;
filter the aggregated data based at least partially on a brand identifier to identify a subset of the plurality of content items within the aggregated data; and
generate, for each content item of the subset, an associated ontological record, each ontological record comprising an identifier of its associated content item, an identifier of an associated content source of the plurality of content sources from which the content item is sourced, and a descriptor of a relationship between the associated content item and one or more content items of the subset.

12. The system of claim 11, wherein the descriptor of the relationship between the associated content item and the one or more items of the subset is an engagement activity.

13. The system of claim 12, wherein each ontological record further comprises a timestamp corresponding to an origin of a content item associated with the ontological record, and wherein the processing device is further to:
for a given time duration of a plurality of time durations and a given content source of the plurality of content sources:
compute a score or ranking based at least partially on one or more of exposure or engagement activities associated with content items that are sourced from the given content source and have associated timestamps that occur within the given time duration.

14. The system of claim 13, wherein the processing device is further to:
generate temporal analysis data to be rendered for display by a display device, wherein a rendered display of the content diffusion data comprises:
a grid having a first axis representing an information metric and a second axis representing the plurality of time durations; and
visual representations of one or more of exposure, engagement, or number of content items arranged in the grid according to content sources and time durations associated with the exposure, engagement, or number of items.

15. The system of claim 11, wherein the processing device is further to:
identify, from the ontological records, an original content item based on relationships between the original content item and one or more related content items or content items of the subset.

16. The system of claim 14, wherein the processing device is further to:
generate content diffusion data to be rendered for display by a display device, wherein a rendered display of the content diffusion data comprises a visual representation of the original content item, visual representations of the one or more related content items, and visual representations of relationships between any displayed visual representations of content items.

17. The system of claim 11, wherein to filter the aggregated data based at least partially on the brand identifier, the processing device is further to:
identify content items having associated engagement or exposure activity that is below a threshold level of engagement or exposure activity; and
exclude the identified content items from the subset of the plurality of content items.

18. The system of claim 11, wherein the brand identifier comprises one or more of a brand name, a business name, a product name, a service name, a mascot name, a celebrity name, a motto, a mission statement, a brand-related message, or a logo image.

19. The system of claim 11, wherein each of the plurality of content items is selected from a group consisting of online content, online news content, a personal web page, a business web page, online encyclopedia content, an forum thread, a forum topic, a forum message, video content, audio content, a blog post, a social media page, and a social media message.

20. A non-transitory, computer-readable storage medium having instructions encoded thereon that, when executed by a processing device, cause the processing device to:
aggregate data from a plurality of content sources, the aggregated data being descriptive of a plurality of content items;
store the aggregated data in the memory;
filter the aggregated data based at least partially on a brand identifier to identify a subset of the plurality of content items within the aggregated data; and
generate, for each content item of the subset, an associated ontological record, each ontological record comprising an identifier of its associated content item, an identifier of an associated content source of the plurality of content sources from which the content item is sourced, and a descriptor of a relationship between the associated content item and one or more content items of the subset.
